(19) United States
(12) Patent Application Publication
(10) Pub. No.: US 2026/0265887 A1
(43) Pub. Date: Sep. 10, 2026

(54) COLD ROLLED AND HEAT TREATED STEEL SHEET AND A METHOD OF MANUFACTURING THEREOF

(71) Applicant: ArcelorMittal, Luxembourg (LU)

(72) Inventors: Venkata Sai Ananth CHALLA, High Point, NC (US); Dongwei FAN, Munster, IN (US)

(21) Appl. No.: 19/166,356

(22) PCT Filed: Apr. 5, 2023
(86) PCT No.: PCT/IB2023/053480

§ 371 Date: Sep. 17, 2025

(51) Int. Cl. C22C 38/04; C21D 6/00; C21D 8/0221; C21D 8/0247; C21D 8/0278; C21D 9/46; C22C 38/00; C22C 38/02; C22C 38/06; C22C 38/44; C22C 38/48; C22C 38/50; C22C 38/54

(52) U.S. Cl. CPC C22C 38/04; C21D 6/004; C21D 8/0226; C21D 8/0236; C21D 8/0263; C21D 8/0278; C21D 9/46; C22C 38/002; C22C 38/02; C22C 38/06; C22C 38/44; C22C 38/48; C22C 38/50; C22C 38/54; C21D 2211/002; C21D 2211/008

(57) ABSTRACT

A cold rolled and heat treated steel sheet including the following elements, 0.3%≤C≤0.45%; 0.4%≤Mn≤1.4%; 0.1%≤Si≤0.9%; 0.01%≤Al≤0.1%; 0.1%≤Cr≤ 0.8%; 0.01%≤Nb≤0.1%; 0.1%≤Ni≤0.9%; 0.01%≤Mo≤0.9%; 0.01%≤Ti≤ 0.1%; 0.0001%≤B≤0.010%; 0%≤P≤0.02%; 0%≤S≤0.03%; 0%≤N≤ 0.09%; 0%≤V≤0.1%; 0%≤Cu≤2%; 0%≤Ca≤0.005%; 0%≤Ce≤0.1%; 0%≤Mg≤0.05%; 0%≤Zr≤0.05%; the remainder composition being composed of iron and unavoidable impurities caused by processing, the microstructure of the steel including, by area percentage, 1 to 5% Bainite, the balance being tempered martensite.

The present invention relates to a cold rolled steel sheet which is suitable for use as a steel sheet for vehicles.

### BACKGROUND

Automotive parts are required to satisfy two inconsistent necessities, namely ease of forming and strength. However in recent years a third requirement of improvement in fuel consumption is also bestowed upon automobiles in view of global environment concerns. Thus, now automotive parts must be made of material having high formability in order to fit in the criteria of ease of fit in the intricate automobile assembly and at same time have to improve strength for vehicle crashworthiness and durability while reducing weight of vehicle to improve fuel efficiency. Furthermore the steel part must be weldable while not suffering from liquid metal embrittlement.

### SUMMARY OF THE INVENTION

Therefore, intense Research and development endeavors have been undertaken to reduce the amount of material utilized in vehicles by increasing the strength of material. Conversely, an increase in strength of steel sheets decreases formability, and thus the development of materials having both high strength and high formability is necessitated.

Earlier research and developments in the field of high strength and high formability steel sheets have resulted in several methods for producing high strength and high formability steel sheets, some of which are enumerated herein for conclusive appreciation of the present invention:

EP3486346 presents a steel sheet having a specified chemical composition and a method for producing the steel sheet. The steel sheet has a microstructure including martensite and bainite. The total area fraction of the martensite and the bainite to the entirety of the microstructure is 95% or more and 100% or less. The balance of the microstructure is at least one of ferrite and retained austenite. The microstructure includes specific inclusion clusters, the content of the inclusion clusters in the microstructure being 5 clusters/mm² or less. The microstructure includes prior-austenite grains having an average size of more than 5 μm. The steel sheet has a tensile strength of 1320 MPa or more. However, the steel of EP3486346 is not able to reach the bendability 2.5 t or less.

The known prior art related to the manufacture of high strength and high formability steel sheets is inflicted by one or the other lacuna: hence there lies a need for a cold rolled steel sheet having strength greater than 1500 MPa and a method of manufacturing the same.

It is an object of the present invention to solve these problems by making available cold-rolled and heat-treated steel sheets that simultaneously have:
an ultimate tensile strength from 1500 MPa to 1750 MPa and preferably from 1580 MPa to 1720 MPa,
a yield strength greater from 1250 MPa to 1450 MPa and preferably from 1280 MPa to 1400 MPa,
a total elongation of 6% or more,
a Hole Expansion Ratio of 40% or more and preferably equal to greater than 45%.

In a preferred embodiment, the cold-rolled and heat-treated steel sheet shows a YS/TS ratio greater than 0.60.

Preferably, such steel can also has a good suitability for forming, in particular for rolling with good weldability and coat ability.

In a preferred embodiment, the cold-rolled and heat-treated steel sheet shows a bendability of less than 3.0 when measured at 90° for r/t. The bending test was conducted according to the ASTM E290-22 standard. The ratio of punch die radius and material thickness was calculated as a representation of the material's bendability.

Another object of the present invention is to make available a method for the manufacturing of these sheets that is compatible with conventional industrial applications while being robust towards manufacturing parameters shifts.

The cold rolled heat treated steel sheet of the present invention may optionally be coated with zinc or zinc alloys, or with aluminum or aluminum alloys to improve its corrosion resistance.

The present invention provides a cold rolled and heat treated steel sheet comprising of the following elements, expressed in percentage by weight:

$$0.3 \% ≦ C ≦ 0.145 \% ;$$

$$0.4 \% ≦ Mn ≦ 1.4 \% ;$$

$$0.1 \% ≦ Si ≦ 0.9 \% ;$$

$$0.01 \% ≦ Al ≦ 0.1 \% ;$$

$$0.1 \% ≦ Cr ≦ 0.8 \% ;$$

$$0.01 \% ≦ Nb ≦ 0.1 \% ;$$

$$0.1 \% ≦ Ni ≦ 0.9 \% ;$$

$$0.01 \% ≦ Mo ≦ 0.9 \% ;$$

$$0.01 \% ≦ Ti ≦ 0.1 \% ;$$

$$0.0001 \% ≦ B ≦ 0.01 \% ;$$

$$0 \% ≦ P ≦ 0.02 \%$$

$$0 \% ≦ S ≦ 0.03 \% ;$$

$$0 \% ≦ N ≦ 0.09 \% ;$$

and can contain one or more of the following optional elements

$$0 \% ≦ V ≦ 0.1 ;$$

$$0 \% ≦ Cu ≦ 2 \% ;$$

$$0 \% ≦ Ca ≦ 0.005 \% ;$$

$$0 \% ≦ Ce ≦ 0.1 \% ;$$

$$0 \% ≦ Mg ≦ 0.05 \% ;$$

$$0 \% ≦ Zr ≦ 0.05 \% ;$$

the remainder composition being composed of iron and unavoidable impurities caused by processing, the microstructure of said steel comprising, by area percentage, 1 to 5% Bainite, the balance being tempered martensite.

The present invention also provides a method of production of a cold rolled and heat treated steel sheet comprising the following successive steps:
providing a steel composition as described above;
reheating said semi-finished product to a temperature from 1000° C. to 1300° C.;
rolling the said semi-finished product in the austenitic range wherein the hot rolling finishing temperature is above 850° C. to obtain a hot rolled steel sheet;
cooling the sheet at a cooling rate of at least 5° C./s to a coiling temperature which is less than or equal to 580° C.; and coiling the said hot rolled sheet in a temperature range from 500° C. to 580° C.;
cooling the said hot rolled sheet to room temperature;
optionally performing scale removal process on said hot rolled steel sheet;
optionally annealing may be performed on hot rolled steel sheet;
optionally performing scale removal process on said hot rolled steel sheet;
cold rolling the said hot rolled steel sheet with a reduction rate from 35% to 90% to obtain a cold rolled steel sheet;
then heating the said cold rolled steel sheet starts from room temperature to a temperature TA from Ac3+10° C. to Ac3+150° C., with a heating rate HR1 from 1° C./s to 30° C./s, where it is held during 100 to 1000 seconds
then cooling the said cold rolled steel sheet starts from TA down to a temperature CS1 from 220° C. to 320° C., with a cooling rate CR1 from 5° C./s to 200° C./s;
then the said cold rolled steel sheet is brought to Ttemper temperature which is from 210° C. to 390° C. and held there during 1 to 500 seconds;
then cooling to room temperature with a cooling rate of at least 1° C./s to obtain a cold rolled and heat treated steel sheet.

Other characteristics and advantages of the invention will become apparent from the following detailed description of the invention.

### DETAILED DESCRIPTION

Carbon is present in the steel from 0.3% to 0.45%. Carbon is an element necessary for increasing the strength of a steel sheet by delaying the formation of ferrite and bainite during cooling after annealing. A content less than 0.3% would not allow the steel of the present invention to have adequate tensile strength as well as ductility. On the other hand, at a carbon content exceeding 0.45%, a weld zone and a heat-affected zone are significantly hardened, and thus the mechanical properties of the weld zone are impaired. Preferable limit for carbon is from 0.31% to 0.4% and more preferred limit is from 0.32% to 0.38%.

Manganese content of the steel of the present invention is from 0.4% to 1.4%. Manganese is an element that imparts strength and an amount of at least 0.4% of manganese is necessary to provide the strength and hardenability of the steel sheet by delaying the formation of Ferrite. Thus, percentage of Manganese such as 0.5% to 1.3% is preferred and more preferably from 0.55% to 0.9%. But when manganese is more than 1.4%, this produces adverse effects such as slowing down the transformation of austenite to martensite, leading to a reduction of ductility in the final product. Moreover, a manganese content above 1.4% would cause central segregation and reduce the weldability of the present steel. Furthermore, high manganese content is detrimental in terms of hydrogen delayed fracture which is an important criterion for steel manufacturers and automotive industry.

Silicon content of the steel of the present invention is from 0.1% to 0.9%. Silicon is an element that contributes to increasing the strength by solid solution strengthening. Silicon is a constituent that can retard the precipitation of carbides during cooling after annealing, therefore, Silicon promotes formation of Martensite. But Silicon is also a ferrite former and increases the Ac3 transformation point which will push the annealing temperature to higher temperature ranges. Therefore that is why the content of Silicon is kept at a maximum of 0.9%. Silicon content above 0.9% can also temper embrittlement and in addition silicon also impairs the coatability. The preferred limit for the presence of Silicon is from 0.2% to 0.8% and more preferably from 0.3% to 0.7%.

The content of aluminum of the steel of the present invention is from 0.01 to 0.1%. Aluminum can be added during the steel making for deoxidizing the steel to trap oxygen. Higher than 0.1% will increase the Ac3 point, thereby lowering the productivity. Additionally, within such range, aluminum bounds nitrogen in the steel to form aluminum nitride to reduce the size of the grains and Aluminum also delays the precipitation of cementite, however when the content of aluminum exceeds 0.1% in the present invention, the amount and size of aluminum nitrides are detrimental to hole expansion and bending and also pushes the Ac3 to higher temperature ranges which are industrially very expensive to reach and causes grain coarsening during annealing soaking. Preferable limit for aluminum is 0.01% to 0.08% and more preferably 0.01% to 0.06%.

Chromium is an essential element of the steel of the present invention, is present from 0.1% to 0.8%. Chromium provides strength and hardening to the steel, but when used above 0.8% impairs surface finish of the steel. The preferred limit for chromium is from 0.2% to 0.7% and more preferably from 0.2% to 0.6%.

Niobium is an essential element and may be present from 0.01% to 0.1%, preferably from 0.01% to 0.09% and more preferably from 0.01% to 0.07%. It is suitable for forming carbonitrides to impart strength to the steel according to the invention by precipitation hardening during the annealing soaking temperature range, this leads to the hardening of the product. However when the niobium content is above 0.1% niobium consumes carbon by forming large amounts of carbo-nitrides which is not favorable for the present invention as large amount of carbo-nitrides tend to reduce the ductility of the steel.

Nickel is an essential element and present in an amount from 0.1% to 0.9% to increase the strength of the steel of the present invention and to improve its toughness. A minimum of 0.01% is preferred to get such effects. The preferred limit for Nickel is from 0.2% to 0.7% and more preferably from 0.3% to 0.6%.

Molybdenum is an essential element and is present from 0.01% to 0.9% in the steel of the present invention. Molybdenum plays an effective role in improving hardenability and hardness, delays the formation of ferrite and bainite during the cooling after annealing, when added in an amount of at least 0.01%. Mo is also beneficial for the toughness of the hot rolled product resulting to an easier manufacturing. However, the addition of Molybdenum excessively increases the cost of the addition of alloy elements, so that for economic reasons its content is limited to 0.9%. The preferable limit for Molybdenum is from 0.01% to 0.7% and more preferably from 0.01% to 0.6%.

Titanium is an essential element which is added to the steel of the present invention from 0.01% to 0.1%, preferably from 0.01% to 0.09%. It is suitable for forming carbides, nitrides and carbonitrides to impart strength to the steel according to the invention by precipitation hardening during the annealing soaking temperature range as a consequence the hardening of the product is done. However, when the titanium content is above 0.1% the titanium consumes carbon by forming large amounts of precipitates and it is not favorable for the present invention as large amount of precipitates tend to reduce the ductility of the steel. The preferable limit for titanium is from 0.01% to 0.08% and more preferably from 0.01% to 0.06%.

Boron is an essential element, which is added from 0.0001% to 0.010%, preferably from 0.001% to 0.004%, to harden the steel. Boron decreases the nitride from Boron Nitride which impart the strength to the steel of the present invention. Boron also imparts hardenability to the steel of the present invention. However, when boron is added more than 0.010% the rollability of the steel sheet is found to be significantly lowered. Further boron segregation may happen at grain boundaries which is detrimental for the formability.

Phosphorus content of the steel of the present invention is limited to 0.02%. Phosphorus is an element which hardens in solid solution. Therefore, a small amount of phosphorus, of at least 0.002% can be advantageous, but phosphorus has its adverse effects, such as a reduction of the spot weldability and the hot ductility, particularly due to its tendency to segregation at the grain boundaries or co-segregation with manganese. For these reasons, its content is preferably limited to a maximum of 0.015%.

Sulfur is not an essential element but may be contained as an impurity in steel. The sulfur content is preferably as low as possible but is 0.03% or less and preferably at most 0.005%, from the viewpoint of manufacturing cost. Further, if higher sulfur is present in steel it combines to form sulfide especially with Mn and Ti which are detrimental for bending, hole expansion and elongation of the steel of the present invention.

Nitrogen is limited to 0.09% to avoid ageing of material and to minimize the precipitation of nitrides during solidification which are detrimental for mechanical properties of the steel.

Vanadium is an optional element which may be added to the steel of the present invention from 0% to 0.1%, preferably from 0.001% to 0.1%. As niobium, it is involved in carbo-nitrides so it plays a role in hardening. But it is also involved to form VN appearing during solidification of the cast product. The amount of Vanadium is limited to 0.1% to avoid coarse VN detrimental for hole expansion. In case the vanadium content is below 0.001% it does not impart any effect on the steel of the present invention.

Copper may be added as an optional element in an amount of 0% to 2% to increase the strength of the steel of the present invention and to improve its corrosion resistance. A minimum of 0.01% is preferred to get such effects. However, when its content is above 2%, it can degrade the surface aspects.

Calcium is an optional element which may be added to the steel of the present invention from 0% to 0.005%, preferably from 0.001% to 0.005%. Calcium is added to steel of the present invention as an optional element especially during the inclusion treatment. Calcium contributes towards the refining of the steel by decreasing the detrimental sulfur content in globulrizing it.

Other elements such as cerium, magnesium or zirconium can be added individually or in combination in the following proportions: Ce≤0.1%, Mg≤0.05% and Zr≤0.05%. Up to the maximum content levels indicated, these elements make it possible to refine the inclusion grain during solidification.

The remainder of the composition of the steel consists of iron and inevitable impurities resulting from processing.

The microstructure of the steel sheet according to the invention comprises 1% to 5% of Bainite, the balance being tempered martensite by area fraction.

The area fractions of phases in the microstructure are determined through the following method: a specimen is cut from the steel sheet, polished and etched with a reagent known per se, to reveal the microstructure. The section is afterwards examined through scanning electron microscope, for example with a Scanning Electron Microscope at a magnification greater than 500×, in secondary electron mode.

The determination of the fraction of ferrite is performed thanks to SEM observations after Nital or Picral/Nital reagent etching.

Tempered Martensite constitutes at least 95% of the microstructure by area fraction. Tempered martensite is formed from the martensite which forms during the cooling after annealing and particularly after below Ms temperature and more particularly below Ms−10° C. Such martensite is then tempered during the holding at a tempering temperature. The tempered martensite of the present invention imparts ductility and strength to such steel. Preferably, the content of tempered martensite is from 96% to 99%.

Bainite is contained in an amount of 1% to 5%. In the frame of the present invention, bainite can comprise carbide-free bainite and/or lath bainite and granular bainite. When present, lath bainite is in form of laths of thickness from 1 micron to 5 microns. When present, carbide-free bainite is a bainite having a very low density of carbides, below 100 carbides per area unit of 100 μm² and possibly containing austenitic islands. When present, granular bainite is in the form of grain with carbides present inside the grains. Bainite provides an improved elongation. The preferred presence for bainite is from 1% to 4%.

In addition to the above-mentioned microstructure, the microstructure of the cold rolled and heat treated steel sheet is free from microstructural components, such as ferrite, fresh martensite, residual austenite pearlite and cementite without impairing the mechanical properties of the steel sheets.

A cold rolled steel sheet according to the invention can be produced by any suitable method. A preferred method consists in providing a semi-finished casting of steel with a chemical composition according to the invention. The casting can be done either into ingots or continuously in form of thin slabs or thin strips, i.e. with a thickness ranging from approximately 220 mm for slabs up to several tens of millimeters for thin strips.

For example, a slab will be considered as a semi-finished product. A slab having the above-described chemical composition is manufactured by continuous casting wherein the slab preferably underwent a direct soft reduction during casting to ensure the elimination of central segregation and porosity reduction. The slab provided by a continuous casting process can be used directly at a high temperature after the continuous casting or may be first cooled to room temperature and then reheated for hot rolling.

The temperature of the slab which is subjected to hot rolling is preferably at least 1000° C., preferably above 1150° C. and must be below 1300° C. In case the temperature of the slab is lower than 1150° C., excessive load is imposed on a rolling mill, and further, the temperature of the steel may decrease to a ferrite transformation temperature during finishing rolling, whereby the steel will be rolled in a state in which transformed ferrite contained in the structure. Further, the temperature must not be above 1300° C. because it is industrially expensive.

The temperature of the slab is preferably sufficiently high so that hot rolling can be completed entirely in the austenitic range, the finishing hot rolling temperature remaining above 850° C. It is necessary that the final rolling be performed above 850° C., because below this temperature the steel sheet exhibits a significant drop in rollability.

The sheet obtained in this manner is then cooled at a cooling rate of at least 5° C./s to a temperature which is below or equal to 580° C. Preferably, the cooling rate will be less than or equal to 100° C./s and above 10° C./s. Thereafter the hot rolled steel sheet is coiled at a coiling temperature from 580° C. to 500° C. and preferably from 500° C. to 570° C. and more preferably from 510° C. to 550° C. Thereafter the coiled hot rolled steel sheet is allowed to cool down, preferably to room temperature. Then the hot rolled sheet may be subjected to on optional scale removal process such as pickling to remove scale formed during hot rolling and ensure that there is no scale on the surface of hot rolled steel sheet before subjecting it to an optional hot band annealing.

The hot rolled sheet may be subjected to an optional hot band annealing at a temperature from 350° C. to 750° C. during 1 to 96 hours. The temperature and time of such hot band annealing is selected to ensure softening of the hot rolled sheet to facilitate the cold rolling of the hot rolled steel sheet. Then the hot rolled sheet may be subjected to an optional scale removal process such as pickling to remove scale formed during hot band annealing.

The hot rolled steel sheet is then cooled down to room temperature, thereafter, the hot rolled sheet is cold rolled with a thickness reduction from 35 to 90% to obtain a cold rolled steel sheet.

The cold rolled steel sheet is then subjected to annealing to impart the steel of the present invention with targeted microstructure and mechanical properties.

In the annealing, the cold rolled steel sheet is subjected to heating wherein the cold rolled steel sheet is heated from room temperature to reach the soaking temperature TA which is from Ac3+10° C. to Ac3+150° C. at a heating rate HR1 from 1° C./s to 30° C./s. It is preferred to have HR1 rate from 1° C./s to 20° C./s and more preferably from 1° C./s to 10° C./s. The preferred TA temperature is from 800° C. to 900° C.

Then the cold rolled steel sheet is held at the annealing soaking temperature TA for 100 to 1000 seconds to ensure adequate transformation to form at least 90% of Austenite at the end of the soaking and preferably 100%. It is then the cold rolled steel sheet is cooled, at an average cooling rate CR1 which is from 5° C./s to 200° C./s, preferably from 8° C./s to 100° C./s and more preferably from 10° C./s to 70° C./s to a cooling stop temperature range CS1 which is from 220° C. to 320° C. and preferably from 230° C. to 310° C. and more preferably from 250° C. to 300° C. During this step of cooling, martensite of is formed. If the CS1 temperature is more than 320° C. the steel of the present invention has too much Austenite which is detrimental for the total elongation.

Then the cold rolled steel sheet is brought to the tempering temperature TT which is from 210° C. to 390° C. and held at TT temperature for a duration of 1 second to 500 seconds. The preferred tempering temperature TT is from 220° C. to 370° C. and more preferably from 250° C. to 350° C. During this tempering step, martensite formed during the cooling step is tempered to form tempered martensite. The duration of tempering is selected in such way that no or a maximum of 2% of residual austenite is left in the cold rolled steel sheet at the end of tempering.

Then the cold rolled steel sheet is cooled to room temperature with a cooling rate of at least 1° C./s to obtain a cold rolled and heat treated steel sheet.

Then the obtained cold rolled heat treated steel sheet may optionally be coated by any of the known method. The coating can be made with zinc or a zinc-based alloy or with aluminum or with an aluminum-based alloy.

An optional post batch annealing, preferably done at 170 to 210° C. during 12 h to 30 h can be performed after coating the product to ensure degassing for coated products. Then cool down to room temperature to obtain a cold rolled and coated steel sheet.

### Examples

The following tests and examples presented herein are non-restricting in nature and must be considered for purposes of illustration only and will display the advantageous features of the present invention and expound the significance of the parameters chosen by inventors after extensive experiments and further establish the properties that can be achieved by the steel according to the invention.

Samples of the steel sheets according to the invention and to some comparative grades were prepared with the compositions gathered in table 1 and the processing parameters gathered in table 2. The corresponding microstructures of those steel sheets were gathered in table 3 and the properties in table 4.

Table 1 depicts the steels with the compositions expressed in percentages by weight and shows Ac3 and Ms for each steel and Ac3 and Ms temperatures are measured in accordance A1033-18 ASTM standards.

TABLE 1
composition of the trials

| | | | | | | | | | | | | | | Ms | Ac3 |
|---|---|---|---|---|---|---|---|---|---|---|---|---|---|---|---|
| Trials | C | Mn | Si | Al | Cr | Ti | Nb | Ni | Mo | B | P | S | N | (° C.) | (° C.) |
| I1 | 0.34 | 0.63 | 0.51 | 0.022 | 0.34 | 0.021 | 0.046 | 0.40 | 0.20 | 0.002 | 0.008 | 0.002 | 0.004 | 334 | 823 |
| I2 | 0.34 | 0.64 | 0.48 | 0.024 | 0.36 | 0.019 | 0.041 | 0.38 | 0.18 | 0.002 | 0.004 | 0.002 | 0.004 | 334 | 823 |
| R1 | 0.23 | 1.2 | 0.24 | 0.048 | 0.19 | 0.031 | 0 | 0 | 0.002 | 0.003 | 0.015 | 0.001 | 0.004 | 380 | 810 |

Table 2 gathers the annealing process parameters implemented on steels of Table 1.

Further, before performing the annealing treatment on the steels of the invention as well as reference, the samples were heated to a temperature from 1150° C. to 1300° C. and hot rolled. All the trials were cold rolled with a cold rolling reduction of 56%.

TABLE 2
process parameters of the trials

| | Hot Rolling | Cooling | |
|---|---|---|---|
| | finish | rate to | Coiling |
| | Temperature | coiling | Temp |
| Trials | (° C.) | (° C./s) | (° C.) |
| I1 | 900 | 21 | 530 |
| I2 | 900 | 21 | 530 |
| R1 | 870 | 20 | 570 |

| | Annealing | | | | | | |
|---|---|---|---|---|---|---|---|
| | Heating rate | | | | Holding at TT | | |
| | to Soaking | | Soaking | | | Holding | |
| | temperature | TA | time | CR1 | CS1 | temperature | Time |
| Trials | (° C./s) | (° C.) | (s) | (° C./s) | (° C.) | (° C.) | (s) |
| I1 | 2.2 | 845 | 186 | 35 | 279 | 279 | 225 |
| I2 | 1.8 | 849 | 225 | 29 | 277 | 277 | 272 |
| R1 | 5 | 850 | 155 | 15 | 250 | 250 | 190 |

Table 3 gathers the results of the test conducted in accordance of the standards on different microscopes such as Scanning Electron Microscope for determining microstructural composition of the trials.

TABLE 3

| | Tempered | Fresh | | Residual | |
|---|---|---|---|---|---|
| | martensite | martensite | Bainite | Austenite | Ferrite |
| Trials | (%) | (%) | (%) | (%) | (%) |
| I1 | 99 | 0 | 1 | 0 | 0 |
| I2 | 99 | 0 | 1 | 0 | 0 |
| R1 | 83 | 2 | 5 | 0 | 10 |

It can be seen from the table above that the trials according to the invention all meet the microstructure targets.

Table 4 gathers the mechanical and surface properties of the steel.

TABLE 4
mechanical properties of the trials
The yield strength YS, the tensile strength TS and
the total elongation TE are measured according to
ASTM E8 standard, published in July 2022. The
hole expansion ratio was measured accordingly
to ISO-16630 standard. The bending test was
conducted according to ASTM E290-22 standard.

| | | Total | | | | |
|---|---|---|---|---|---|---|
| | TS | elongation | YS | | | |
| Trials | (MPa) | (%) | (MPa) | YS/TS | HER | Bendability |
| I1 | 1671 | 8.6 | 1333 | 0.79 | 56 | 2.1 |
| I2 | 1640 | 7.3 | 1353 | 0.82 | 45 | 2.5 |
| R1 | 1492 | 7.8 | 1144 | 0.76 | Not | Not |
| | | | | | measured | measured |

What is claimed is:

1.-14. (canceled)

15. A cold rolled and heat treated steel sheet comprising a composition with the following elements, expressed in percentage by weight:
$$0 \text{.3} \% ≦ C ≦ 0.45 \% ;$$
$$0 \text{.4} \% ≦ Mn ≦ 1.4 \% ;$$
$$0 \text{.1} \% ≦ Si ≦ 0.9 \% ;$$
$$0.01 \% ≦ Al ≦ 0.1 \% ;$$
$$0.1 \% ≦ Cr ≦ 0.8 \% ;$$
$$0 \text{.01} \% ≦ Nb ≦ 0.1 \% ;$$
$$0 \text{.1} \% ≦ Ni ≦ 0.9 \% ;$$
$$0 \text{.01} \% ≦ Mo ≦ 0.9 \% ;$$
$$0 \text{.01} \% ≦ Ti ≦ 0.1 \% ;$$
$$0.0001 \% ≦ B ≦ 0.01 \% ;$$
$$0 \% ≦ P ≦ 0.02 \% ;$$
$$0 \% ≦ S ≦ 0.03 \% ;$$
$$0 \% ≦ N ≦ 0.09 \% ;$$
and optionally one or more of the following elements
$$0 \% ≦ V ≦ 0.1 \% ;$$
$$0 \% ≦ Cu ≦ 2 \% ;$$
$$0 \% ≦ Ca ≦ 0.005 \% ;$$
$$0 \% ≦ Ce ≦ 0.1 \% ;$$
$$0 \% ≦ Mg ≦ 0.05 \% ;$$
$$0 \% ≦ Zr ≦ 0.05 \% ;$$
a remainder of the composition being composed of iron and unavoidable impurities caused by processing,
a microstructure comprising, by area percentage, 1 to 5% Bainite, the balance being tempered martensite.

16. The cold rolled and heat treated steel sheet as recited in claim 15 wherein the composition includes 0.31% to 0.4% of carbon.

17. The cold rolled and heat treated steel sheet as recited in claim 15 wherein the composition includes 0.5% to 1.3% of Manganese.

18. The cold rolled and heat treated steel sheet as recited in claim 15 wherein the composition includes 0.01% to 0.08% of Aluminum.

19. The cold rolled and heat treated steel sheet as recited in claim 15 wherein the composition includes 0.2% to 0.8% of Silicon.

20. The cold rolled and heat treated steel sheet as recited in claim 15 wherein the bainite is from 1% to 4%.

21. The cold rolled and heat treated steel sheet as recited in claim 15 wherein the tempered martensite is from 96% to 99%.

22. The cold rolled and heat treated steel sheet as recited in claim 15 wherein the sheet has an ultimate tensile strength from 1500 MPa to 1750 MPa, and a yield strength from 1250 MPa to 1450 MPa.

23. A method of production of a cold rolled and heat treated steel sheet comprising the following successive steps:
providing a semi-finished product with a composition with the following elements, expressed in percentage by weight:
$$0.3 \% ≦ C ≦ 0.45 \%$$
$$0 \text{.4} \% ≦ Mn ≦ 1.4 \%$$
$$0 \text{.1} \% ≦ Si ≦ 0.9 \% ;$$
$$0.01 \% ≦ Al ≦ 0.1 \% ;$$
$$0.1 \% ≦ Cr ≦ 0.8 \% ;$$
$$0.01 \% ≦ Nb ≦ 0.1 \% ;$$
$$0.1 \% ≦ Ni ≦ 0. 9 \% ;$$
$$0.01 \% ≦ Mo ≦ 0.9 \% ;$$
$$0 \text{.01} \% ≦ Ti ≦ 0.1 \% ;$$
$$0 \text{.0001} \% ≦ B ≦ 0.01 \% ;$$
$$0 \% ≦ P ≦ 0.02 \% ;$$
$$0 \% ≦ S ≦ 0.03 \% ;$$
$$0 \% ≦ N ≦ 0.09 \% ;$$
and optionally one or more of the following elements
$$0 \% ≦ V ≦ 0.1 \% ;$$
$$0 \% ≦ Cu ≦ 2 \% ;$$
$$0 \% ≦ Ca ≦ 0.005 \% ;$$
$$0 \% ≦ Ce ≦ 0.1 \% ;$$
$$0 \% ≦ Mg ≦ 0.05 \% ;$$
$$0 \% ≦ Zr ≦ 0.05 \% ;$$
a remainder of the composition being composed of iron and unavoidable impurities caused by processing,
reheating the semi-finished product to a temperature from 1000° C. to 1300° C.;
hot rolling the semi-finished product in the austenitic range wherein a hot rolling finishing temperature is above 850° C. to obtain a hot rolled steel sheet;
cooling the hot rolled steel sheet at a cooling rate of at least 5° C./s to a coiling temperature less than or equal to 580° C.; and coiling the hot rolled sheet in a temperature range from 500° C. to 580° C.;
cooling the hot rolled sheet to room temperature;
optionally performing a scale removal process on said hot rolled steel sheet;
optionally annealing the hot rolled steel sheet;
optionally performing a further scale removal process on the hot rolled steel sheet;
cold rolling the hot rolled steel sheet with a reduction rate from 35% to 90% to obtain a cold rolled steel sheet;
then heating the cold rolled steel sheet starting from room temperature to a temperature TA from Ac3+10° C. to Ac3+150° C., with a heating rate HR1 from 1° C./s to 30° C./s, and holding for 100 to 1000 seconds
then cooling the cold rolled steel sheet starting from TA down to a temperature CS1 from 220° C. to 320° C., with a cooling rate CR1 from 5° C./s to 200° C./s;
then bringing the cold rolled steel sheet to a Ttemper temperature from 210° C. to 390° C. and holding for 1 to 500 seconds;
then cooling to room temperature with a cooling rate of at least 1° C./s to obtain a cold rolled and heat treated steel sheet.

24. The method according to claim 23 wherein said coiling temperature is from 500° C. to 570° C.

25. The method according to claim 23 wherein rein CS1 is from 230° C. to 310° C.

26. The method according to claim 23 wherein in HR1 is from 1° C./s to 20° C./s.

27. The method according to claim 23 wherein TA is from 800° C. to 900° C.

28. A method for manufacturing a structural part of a vehicle comprising employing the steel sheet as recited in claim 15.

28. A method for manufacturing a structural part of a vehicle comprising manufacturing a steel sheet according to the method as recited in claim 23.
